(19) United States
(12) Patent Application Publication
(10) Pub. No.: US 2003/0035204 A1
(43) Pub. Date: Feb. 20, 2003

(54) Two-stage L-band erbium-doped fiber amplifier and method thereof

(76) Inventors: Joon Tae Ahn, Taejon (KR); Min Yong Jeon, Taejon (KR); Kyong Hon Kim, Taejon (KR)

Correspondence Address: JACOBSON HOLMAN, PLLC, PROFESSIONAL LIMITED LIABILITY COMPANY, 400 Seventh Street, N.W., Washington, DC, 20004, US

(21) Appl. No.: 10/003,289

(22) Filed: Dec. 6, 2001

(30) Foreign Application Priority Data
Aug. 16, 2001 (KR) 2001-49358

(51) Int. Cl. H01S 3/00

(52) U.S. Cl. 359/341.3

(57) ABSTRACT

The present invention utilizes an amplified spontaneous emission (ASE) as a pumping source, thereby enhancing an amplification capability of a two-stage L-band EDFA. The two-stage L-band EDFA of the present invention includes a first amplifier and a second amplifier. The first amplifier is designed as a reflective amplifier, thereby re-amplifying a forward ASE by means of a gain medium. The first amplifier has a pumping LD, a WDM coupler, a first EDF and a Faraday rotating mirror. The second amplifier plays a role in amplifying an optical signal by utilizing the re-amplified forward ASE and the backward ASE as the pumping light. Here, the forward ASE and the backward ASE are transmitted to the second amplifier through an optical circulator. The second amplifier has a second EDF and an optical isolator.

### FIELD OF THE INVENTION

The present invention relates to a two-stage optical amplifier; and, more particularly, to a two-stage long wavelength band (L-band) erbium-doped fiber amplifier (EDFA) having low noise figure and high gain characteristic by utilizing amplified spontaneous emission (ASE) as a pumping light in a second amplification stage.

### DESCRIPTION OF THE PRIOR ART

Optical telecommunications service providers continue to demand more data capacity and higher data transmission speeds to service their customers' current and future requirements. To meet the requirements, a wavelength division multiplexing (WDM) optical communication technology has been developed in recent years, and further, many researches for a low noise performance and high efficiency optical amplifier has been advanced for increasing a transmission capacity to date. The optical amplifier is the most important part in the WDM optical communication technology. In particular, among the optical amplifiers for use in the optical communication system, an erbium-doped fiber amplifier (EDFA), using an erbium-doped fiber (EDF) as a gain medium, is widely used.

An amplification band of the EDFA is mainly classified into two ranges. That is, one is a conventional wavelength band (C-band) ranging from 1,530 nm to 1,560 nm and the other is a long wavelength band (L-band) in a range of 1,570 nm to 1,610 nm. Therefore, it is possible to obtain an amplification bandwidth over than 60 nm providing that the C-band EDFA and the L-band EDFA are connected in parallel.

Many researches for the C-band EDFA have been advanced for ten years because the wavelength band of the C-band EDFA is nearly identical to the wavelength of a transmission optical fiber representing a low optical loss, i.e., approximately 1,550 nm. In comparison with the C-band EDFA, the L-band EDFA has been researched for last few years. Especially, in order to obtain the noise figure gain value as similar as those of the C-band EDFA, the length of the EDF should be lengthened or the pumping light should have high intensity. This is caused by a low gain value and a low population inversion of the L-band EDFA.

One of technologies for enhancing the amplification characteristic of the L-band EDFA is to utilize an amplified spontaneous emission (ASE) generated from the gain medium. Regarding this technology, several articles have been published, which are introduced hereinafter.

One technology is to utilize the ASE as the pumping light of the EDF without a pumping laser diode (LD), thereby improving a power conversion efficiency (PCE) of the pumping light, which is disclosed by J. H. Lee et al. in an article, “Enhancement of Power Conversion Efficiency for an L-band EDFA with a Secondary Pumping Effect in the Unpumped EDF Section, IEEE J. Photon. Tech. Lett, pp.42-44, 1999”.

Another technology is disclosed by M. Shigematsu et al. in an article “A Novel Configuration of L-band Erbium-Doped Fiber Amplifier for Improved Efficiency, Proc. ECOC99, PP. 1270-I-271, Sep. 26-30, 1999 at Nice in France”. In the article, a backward pumping ASE generated from the L-band EDFA of a forward pumping scheme, is re-transmitted to an output end of the EDF by using an optical circulator, thereby utilizing the backward ASE as the backward pumping source.

The other technology is disclosed by A. Buxens et al. in an article “Gain Flatten L-band EDFA Based on Upgraded C-band EDFA Using Forward ASE Pumping in an EDF Section, Electron. Lett. Vol. 36, pp.821-823, 2000”. In a disclosure, the C-band EDFA can be upgraded to the L-band EDFA by just connecting an unpumped EDF to the output end of the C-band EDFA.

As described above, the ASE generated from the EDF is utilized as the pumping light in the L-band EDFA. Accordingly, as the intensity of the ASE is higher, the amplification characteristic such as the gain, saturation output and the like are improved.

Referring to FIG. 1A, there is shown a first conventional L-band EDFA comprising a pumping LD 10 for providing the pumping light, a WDM coupler 30 for coupling the pumping light to a gain medium, and an EDF 20 of the gain medium for amplifying an optical signal.

When the pumping light from the pumping LD 10 is inputted into the EDF 20 through the WDM coupler 30, erbium (Er) atoms of the EDF 20 are excited from a ground state to an excited state. Thereafter, the excited atoms go back to the ground state again by a spontaneous emission and a stimulated emission while emitting the light. Here, the stimulated emission is to emit the light of which the wavelength is same to that of the inputted optical signal and the spontaneous emission is to emit the light having an arbitrary wavelength without the inputted optical signal. When the pumping light is inputted into the EDF 20, the inputted optical signal is amplified by the stimulated emission. At the same time, the spontaneous emission generated from the EDF 20 is also amplified while the spontaneous emission is transmitted through the EDF 20. This is referred to the ASE.

The ASE is classified into two types according to transmission direction. That is, when the transmission direction of the ASE is identical to that of the pumping light, it is referred to a forward ASE. Meanwhile, when the ASE is transmitted in opposition to the direction of the pumping light, it is referred to a backward ASE. Generally, the intensity of the backward ASE is higher than that of the forward ASE.

Since the center wavelength of the ASE is approximately 1,530 nm and the wavelength range is within the C-band, the ASE may be utilized as the pumping light for exciting the L-band EDFA. However, the gain of the L-band EDFA is lower than that of the C-band EDFA so that the length of the L-band EDFA should be lengthened in order to obtain the gain value as similar as that of the C-band EDFA.

Therefore, the pumping light generated from the pumping LD 10 is absorbed at a rear position of the EDF 20. As the pumping light is transmitted to the rear position of the EDF 20, the pumping light is entirely absorbed eventually. At this time, the ASE generated at a front position of the EDF 20 by the pumping light, plays a role as the pumping light at the rear position of the EDF 20. Thus, the inputted optical signal is amplified at the front position of the EDF 20 by the pumping light generated from the pumping LD 10. In addition, the inputted optical signal is also amplified at the rear position of the EDF 20 by the ASE.

Referring to FIG. 1B, there is shown a second conventional L-band EDFA comprising a pumping LD 10 for providing the pumping light, a WDM coupler 30 for coupling the pumping light to a gain medium, a second EDF 20 and a first EDF 15. The second EDF 20 plays a role in amplifying an inputted optical signal and generating a forward ASE and a backward ASE, wherein the backward ASE is utilized as the pumping light for amplifying the inputted optical signal at the first EDF 15.

In the second conventional L-band EDFA scheme, an operation mechanism is same to that of the first conventional L-band EDFA. But the backward ASE is utilized as the pumping light in the first EDF 15 so that it is possible to use the pumping LD 10 effectively.

Referring to FIG. 1C, there is shown a third conventional L-band EDFA comprising a first EDF 15, a second EDF 20, a pumping LD 10, a WDM coupler 30, a first optical circulator 40, a second optical circulator 50 and an optical isolator 60.

A backward ASE generated from the first EDF 15 by the pumping LD 10 is inputted into the second EDF 20 through the first optical circulator, thereby pumping the second EDF 20 optically. Here, each optical circulator 40, 50 has three ports, wherein the optical signal is transmitted only from a first port 1 into a second port 2 and from the second port 2 to a third port 3. The optical isolator 60, disposed between the first optical circulator 40 and the second optical circulator 50, plays an important role in preventing the optical signal from being transmitted backward However, in the conventional L-band EDFA schemes as described above, there is a drawback that it is difficult to obtain the ASE of high intensity in a reflective optical amplifier. Moreover, it is also difficult to expect an improved amplification characteristic because the inputted optical signal is amplified only one time.

### SUMMARY OF THE INVENTION

It is, therefore, an object of the present invention to provide a two-stage long wavelength (L-band) erbium-doped fiber amplifier (EDFA) by utilizing an amplified spontaneous emission (ASE) as a pumping source.

In accordance with an aspect of the present invention, there is provided a two-stage long wavelength band (L-band) erbium-doped fiber amplifier (EDFA), including: a first amplifier for re-amplifying a forward amplified spontaneous emission (ASE) by means of a gain medium which is reflected by an optical mirror, wherein the forward ASE and a backward ASE are generated by a pumping light inputted through a wavelength division multiplexing (WDM) coupler; and a second amplifier for amplifying an optical signal by utilizing the re-amplified forward ASE and the backward ASE as the pumping light, wherein the forward ASE and the backward ASE are transmitted to the second amplifier through an optical circulator.

In accordance with an aspect of the present invention, there is provided a method for amplifying an optical signal in two-stage long wavelength band (L-band) erbium-doped fiber amplifier (EDFA), the method comprising the steps of: a) re-amplifying a forward amplified spontaneous emission (ASE) by means of a gain medium which is reflected by an optical mirror, wherein the forward ASE and a backward ASE are generated by a pumping light inputted through an optical coupler; and b) amplifying an optical signal by utilizing the re-amplified forward ASE and the backward ASE as the pumping light, wherein the forward ASE and the backward ASE are transmitted to the second pumping means through an optical circulator.

### BRIEF DESCRIPTION OF THE DRAWINGS

The above and other objects and features of the present invention will become apparent from the following description of the preferred embodiment given in conjunction with the accompanying drawings, in which:

FIGS. 1A to 1C are schematic views setting forth conventional long wavelength band (L-band) erbium-doped fiber amplifiers (EDFA);

FIG. 2 is a schematic view illustrating a two-stage L-band EDFA in accordance with the preferred embodiment of the present invention;

FIG. 3 is a graph showing a measured gain and a noise figure for comparing the present invention and the prior art; and

FIG. 4 is a graph representing the measured gain of the L-band EDFA according to the length of the EDF.

### DETAILED DESCRIPTION OF THE PREFERRED EMBODIMENTS

Referring to FIG. 2, there is shown a two-stage long wavelength band (L-band) erbium-doped fiber amplifier (EDFA) in accordance with the preferred embodiment of the present invention, which comprises a first amplification stage and a second amplification stage. The first amplification stage includes an optical circulator 100, a first erbium-doped fiber (EDF) 300, a pumping laser diode (LD) 200 for pumping the first EDF 300 to induce a forward amplified spontaneous emission (ASE) and a backward ASE, a wavelength division multiplexing (WDM) coupler 150 for coupling an inputted optical signal and the pumping light and a Faraday rotating mirror (FRM) 400, disposed at the end of the first amplification stage, for reflecting the optical signal. Here, the optical circulator 100 has three ports therein for enabling the optical signal to progress forward and to cut off backward. That is, the optical signal progresses from a first port 1 to a second port 2 and from the second port 2 to a three port 3 by means of the optical circulator 100. The second amplification stage includes a second EDF 500 for amplifying the optical signal and an optical isolator 600 for preventing an optical signal from being transmitted backward.

The first amplification stage is designed as a reflective optical amplifier. Therefore, an inputted optical signal is transmitted through the first EDF 300 twice, whereby the inputted optical signal is amplified and a high gain is achieved. Here, the ASE generated from the first EDF 300 by the pumping light will be set forth in detail hereinafter.

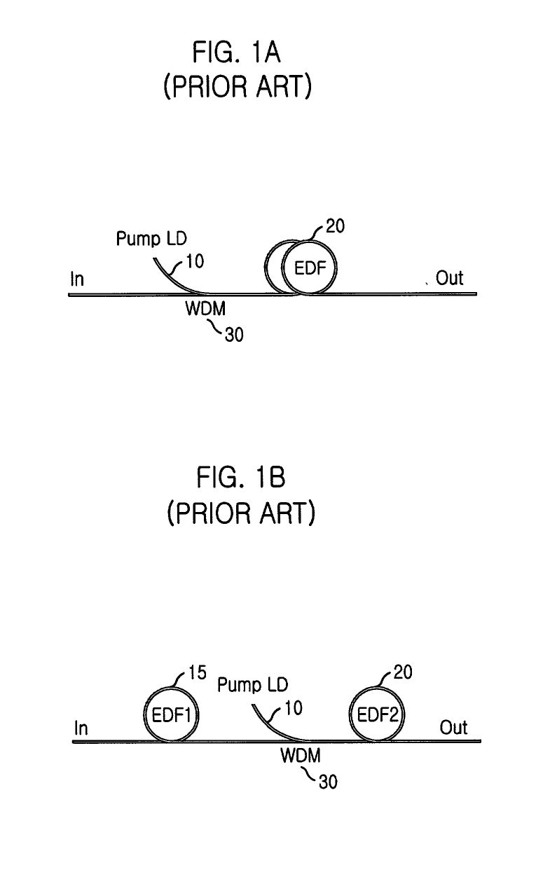

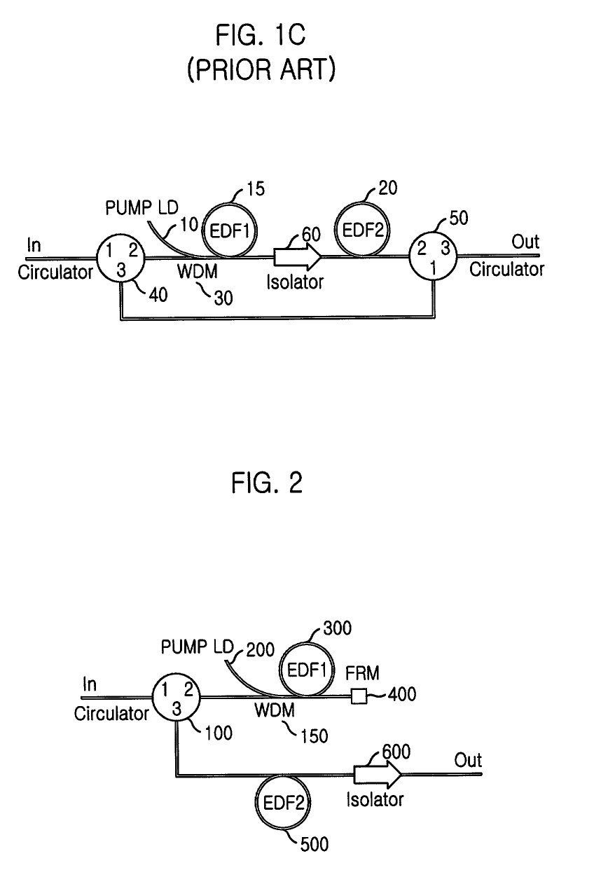

First of all, because the inputted optical signal and the forward ASE are reflected by the FRM 400 of the first amplification stage, the forward ASE is transmitted through the first EDF 300 twice like the inputted optical signal so that the forward ASE are amplified intensely. Thereafter, the forward ASE and the backward ASE are transmitted through the second port 2 of the optical circulator 100 and are transmitted to the second amplification stage through the third port 3 of the optical circulator 100. In comparison with the conventional L-band EDFA as represented in FIG. 1C, the backward ASE has the same condition but the forward ASE is re-amplified at the first EDF 300 in the inventive L-band EDFA than the conventional L-band EDFA. In the second amplification stage, the ASE transmitted from the first amplification stage is utilized as a pumping light for pumping the second EDF 500 optically.

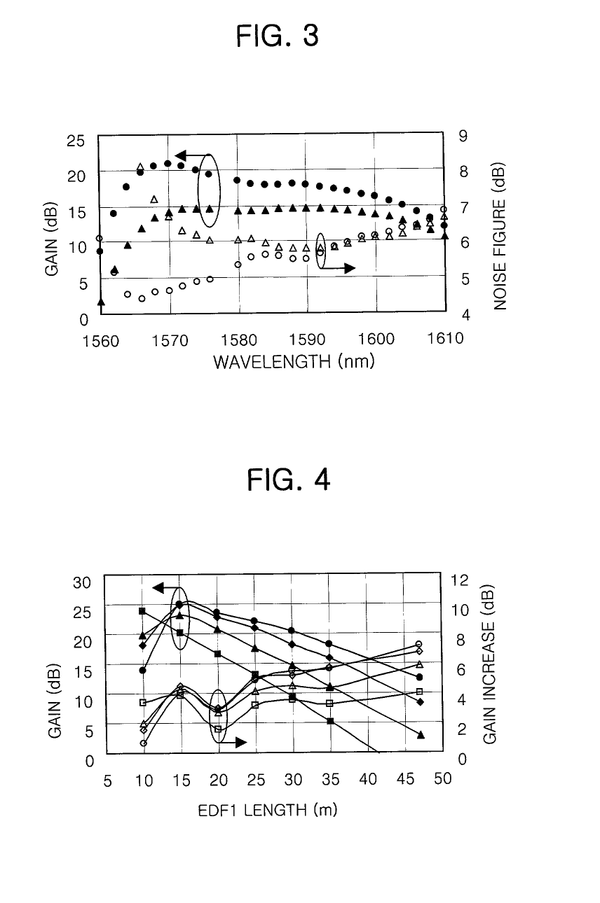

Referring to FIG. 3, there is shown a graph representing a measured gain value and a noise figure, wherein closed circles denote the gain value of the inventive L-band EDFA and closed triangles denote the gain value of the conventional L-band EDFA as shown in FIG. 1C. Furthermore, open circles represent the noise figure of the L-band EDFA in accordance with the present invention and open triangles represent the noise figure of the conventional L-band EDFA as shown in FIG. 1C.

In order to compare the gain and the noise figure of the present invention with those of the conventional L-band EDFA, experimental conditions are fixed as followings: an absorption coefficient of the EDF is approximately 5.5 dB/m at approximately 1,530 nm; lengths of the first EDF and the second EDF are 15 m and 80 m respectively; a 980 nm-laser diode is used as a pumping means and a pumping power is approximately 85 mW; the wavelength of a saturation tone of which the intensity is −15 dBm, is fixed to 1,570 nm. Under these experimental conditions, the gain and the noise figure are measured while the wavelength of the optical signal of which intensity is −30 dBm, is varied from 1,560 nm to 1,610 nm.

As shown in FIG. 3, it is understood that the gain of the inventive L-band EDFA is higher than that of the prior art and the noise figure is also improved.

Referring to FIG. 4, there is a graph representing the gain versus the length of the first EDF in accordance with the present invention, wherein closed symbols denote the gain value of the inventive L-band EDFA and the open symbols denote that of the conventional L-band EDFA as shown in FIG. 1C. Here, a square, a triangle, a diamond and a circle symbols represent the gain values measured at 1,572 nm, 1,584 nm, 1,596 nm and 1,608 nm, respectively. Moreover, the power of the pumping LD is fixed to 85 mW and the length of the second EDF is fixed to 80 m. From this graph, it is apparent that the gain has a maximum value when the length of the first EDF is 15 m and the gain is reduced on and on when the length is above 15 m. In practice, the intensity of the ASE represents the maximum value when the length of the first EDF is 15 m regardless of the inventive and conventional L-band EDFAs. It should be noted that the length of the first EDF having the maximum gain value is varied according to the intensity of the pumping light and the kind of the EDF. The increase of the gain value of the inventive L-band EDFA is always positive. Thus, it is understood that the inventive L-band EDFA has higher gain value than that of the conventional L-band EDFA.

In conclusion, in comparison with the prior art, the inputted optical signal and the ASE are amplified intensely in the inventive L-band EDFA, especially the forward ASE, because the inputted signal and the forward ASE pass the gain medium twice after reflecting the optical mirror, thereby improving the amplification characteristic.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A two-stage long wavelength band (L-band) erbium-doped fiber amplifier (EDFA), comprising:
a first amplification means for re-amplifying a forward amplified spontaneous emission (ASE) by means of a gain medium which is reflected by an optical mirror, wherein the forward ASE and a backward ASE are generated by a pumping light inputted through an optical coupler; and
a second amplification means for amplifying an optical signal by utilizing the re-amplified forward ASE and the backward ASE as the pumping light, wherein the forward ASE and the backward ASE are transmitted to the second pumping means through an optical circulator.

2. The two-stage L-band EDFA as recited in claim 1, wherein the first amplification means includes:
a pump laser for generating the pumping light;
a wavelength division multiplexing (WDM) coupler for coupling the optical signal and the pumping light;
a first EDF for amplifying the optical signal and generating the forward ASE and the backward ASE; and
a Faraday rotating mirror (FRM) for reflecting the optical signal and the forward ASE.

3. The two-stage L-band EDFA as recited in claim 1, wherein the second amplification means includes:
a second EDF for amplifying the inputted optical signal by utilizing the ASE transmitted from the first pumping means as the pumping light; and
an optical isolator for preventing the inputted optical signal from being transmitted backward.

4. A method for amplifying an optical signal in two-stage long wavelength band (L-band) erbium-doped fiber amplifier (EDFA), the method comprising the steps of:
a) re-amplifying a forward amplified spontaneous emission (ASE) by means of a gain medium which is reflected by an optical mirror, wherein the forward ASE and a backward ASE are generated by a pumping light inputted through an optical coupler; and
b) amplifying an optical signal by utilizing the re-amplified forward ASE and the backward ASE as the pumping light, wherein the forward ASE and the backward ASE are transmitted to the second pumping means through an optical circulator.

5. The method as recited in claim 4, wherein the step a) includes the steps of:
a1) generating the pumping light;
a2) coupling the optical signal and the pumping light;
a3) amplifying the optical signal and generating the forward ASE and the backward ASE; and
a4) reflecting the inputted optical signal and the forward ASE.

6. The method as recited in claim 4, wherein the step b) includes the steps of:
b1) amplifying the inputted optical signal by utilizing the ASE transmitted from the first pumping means as the pumping light; and
b2) preventing the inputted optical signal from being transmitted backward.
